(19) United States
(12) Patent Application Publication
(10) Pub. No.: US 2023/0040847 A1
(43) Pub. Date: Feb. 9, 2023

(54) Non-Blocking Multilayer Elastic Composition

(71) Applicant: Kimberly-Clark Worldwide, Inc., Neenah, WI (US)

(72) Inventors: Glynis Walton, Roswell, GA (US); Shawn Jenkins, Suwanee, GA (US); J. David Tucker, Canton, GA (US); Howard M. Welch, Woodstock, GA (US); Bryan D. Haynes, Jasper, GA (US); Steve R. Stopper, Jasper, GA (US)

(21) Appl. No.: 17/792,209

(22) PCT Filed: Feb. 24, 2020
(86) PCT No.: PCT/US2020/019476

§ 371 Date: Jul. 12, 2022

(51) Int. Cl. C08L 23/14; B32B 3/04; B32B 27/12; B32B 27/08; B32B 27/32; B32B 27/16

(52) U.S. Cl. CPC C08L 23/14; B32B 3/04; B32B 27/12; B32B 27/08; B32B 27/32; B32B 27/16; B32B 5/022

(57) ABSTRACT

An elastomeric composition, including at least one skin layer and a core layer, with non-blocking properties such that the elastomeric composition can be wound is provided. The core layer includes an elastomer, and the skin layer includes an elastomer, which may be the same or different from the core layer, and a non-elastic polyolefin. Further, the skin layer can be present as a small portion of the total elastomeric composition, and may maintain the elastic efficiency of the composition.

### BACKGROUND OF THE INVENTION

Elastic compositions, such as elastic films and fibers, are used in a wide variety of applications, examples of which include waistbands, side panels, leg gasketing and outercovers/backsheets for limited use or disposable products including personal care absorbent articles. As may be known in the art, such articles may include child and adult diapers, training pants, swimwear, incontinence garments, feminine hygiene products, mortuary products, wound dressings, bandages and the like. Elastic compositions also have applications in the protective cover area, such as car, boat or other object cover components, tents (outdoor recreational covers), agricultural fabrics (row covers) and in the veterinary and health care area in conjunction with such products as surgical drapes, hospital gowns and fenestration reinforcements. Additionally, such materials have applications in other apparel for clean room and health care settings.

While elastic compositions have many uses, the compositions, such as films and fibers, tend to stick to themselves, due at least in part to their low glass transition temperature (Tg) and a high degree of tackiness. This makes rolling preparing films and laying nonwoven webs difficult as elastic compositions in rolled or layered forms tend to block between the adjacent layers. In the past, it was attempted to add a non-blocking, non-elastic, outer layer to the film or fiber sheath. However, it was found that such non-blocking layers negatively impacted the stretch and retraction properties of the elastic composition. Similarly, it was also attempted to form an outer layer using elastic resins with higher glass transition temperatures. However, these resins still impacted the stretch properties of the composition, and also impacted the ability of the composition to be laminated and/or aperture after formation.

As such, it would be a benefit to provide an elastic composition that exhibits non-blocking properties without negatively effecting the elastic efficiency of the composition. Moreover, it would be a benefit to provide an elastic composition that has excellent elastic efficiency that can be wound prior to stretching and/or lamination. It would be a further benefit to provide an elastic composition that exhibits non-blocking properties that can be laminated to one or more additional layers.

### SUMMARY OF THE INVENTION

In general, the present disclosure is directed to an elastomeric composition that includes a core layer and at least one skin layer. The at least one skin layer forms 30 wt. % or less of the total weight of the elastomeric composition and includes an olefin based elastomer and at least one non-elastomeric polyolefin.

In one aspect, the elastomeric composition is a film. In an aspect, the film includes a core layer and one skin layer. Furthermore, in one aspect, the film includes a core layer, a first skin layer, and a second skin layer.

In a further aspect, the elastomeric composition is a fiber. Moreover, in one aspect, the fiber includes a core surrounded by a single skin layer.

In yet another aspect, the olefin-based elastomer is an ethylene/α-olefin copolymer, a propylene/α-olefin copolymer, or a combination thereof. Moreover, in one aspect, the core layer includes a core olefin based elastomer, where the core olefin-based elastomer is an ethylene/α-olefin copolymer, a propylene/α-olefin copolymer, or a combination thereof. In another aspect, the core layer includes a core olefin based elastomer and a second olefin based elastomer. Furthermore, in an aspect, the core olefin based elastomer and the second olefin based elastomer are an ethylene/α-olefin copolymer. In one aspect, the olefin-based elastomer and the core olefin based elastomer and/or second olefin based elastomer are formed from different elastomers. Additionally or alternatively, in an aspect, the olefin based elastomer comprises a propylene/α-olefin copolymer. In another aspect, the core olefin based elastomer and/or second olefin based elastomer comprises an ethylene/α-olefin copolymer. In a further aspect, the olefin based elastomer is an ethylene/α-olefin copolymer. In another aspect, the core olefin based elastomer and/or second olefin based elastomer is a propylene/α-olefin copolymer. Furthermore, in one aspect, the olefin based elastomer has a lower average molecular weight than the core olefin based elastomer, second olefin based elastomer, or an average molecular weight of the core olefin based elastomer and the second olefin based elastomer. In yet a further aspect, a ratio of an average molecular weight of the core olefin based elastomer, second olefin based elastomer, or average of the core olefin based elastomer and the second olefin based elastomer, to an average molecular weight of the olefin based elastomer is from about 10:1 to 1.1:1

Additionally or alternatively, in one aspect, the non-elastomeric olefin is a linear low density polyethylene. Furthermore, in an aspect, the non-elastomeric olefin forms about 20 wt. % or less of the total weight of the elastomeric composition. In yet another aspect, the non-elastomeric olefin forms about 15% or less of the total weight of the elastomeric composition.

In one aspect, the at least one skin layer further includes inorganic particles. In yet another aspect the at least one skin layer has an inner side adjacent to the core and an outer side opposite the inner side, wherein the outer side is embossed or patterned.

Moreover, in an aspect, the elastomeric composition is wound after formation. Additionally or alternatively, the elastomeric composition is wound prior to stretching or lamination.

Other features and aspects of the present invention are described in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1A illustrates a cross-sectional view of an elastomeric composition made in accordance with the present disclosure;

FIG. 1B illustrates a cross-sectional view of an elastomeric composition made in accordance with the present disclosure;

FIG. 1C illustrates a cross-sectional view of an elastomeric composition made in accordance with the present disclosure as part of a laminate; and

FIG. 2 illustrates a cross-sectional view of an elastomeric composition made in accordance with the present disclosure.

Repeat use of reference characters in the present specification and drawings is intended to represent same or analogous features or elements of the invention.

### DETAILED DESCRIPTION OF REPRESENTATIVE EMBODIMENTS

### Definitions

As used herein, the terms “about,” “approximately,” or “generally,” when used to modify a value, indicates that the value can be raised or lowered by 10% and remain within the disclosed aspect.

As used herein, the term “elastomeric” and “elastic” and refers to a material that, upon application of a stretching force, is stretchable in at least one direction (such as the CD or MD direction), and which upon release of the stretching force, contracts/returns to approximately its original dimension. For example, a stretched material may have a stretched length that is at least 50% greater than its relaxed unstretched length, and which will recover to within at least 50% of its stretched length upon release of the stretching force. A hypothetical example would be a one (1) inch sample of a material that is stretchable to at least 1.50 inches and which, upon release of the stretching force, will recover to a length of not more than 1.25 inches. Desirably, the material contracts or recovers at least 50%, and even more desirably, at least 80% of the stretched length.

As used herein, the term “fibers” generally refer to elongated extrudates that may be formed by passing a polymer through a forming orifice, such as a die. Unless noted otherwise, the term “fibers” includes discontinuous fibers having a definite length (e.g., stable fibers) and substantially continuous filaments. Substantially filaments may, for instance, have a length much greater than their diameter, such as a length to diameter ratio (“aspect ratio”) greater than about 15,000 to 1, and in some cases, greater than about 50,000 to 1.

As used herein the term “extensible” generally refers to a material that stretches or extends in the direction of an applied force (e.g., CD or MD direction) by about 50% or more, in some embodiments about 75% or more, in some embodiments about 100% or more, and in some embodiments, about 200% or more of its relaxed length or width.

As used herein the term “nonwoven web” generally refers to a web having a structure of individual fibers or threads which are interlaid, but not in an identifiable manner as in a knitted fabric. Examples of suitable nonwoven fabrics or webs include, but are not limited to, meltblown webs, spunbond webs, bonded carded webs, airlaid webs, coform webs, hydraulically entangled webs, and so forth.

As used herein, the term “meltblown web” generally refers to a nonwoven web that is formed by a process in which a molten thermoplastic material is extruded through a plurality of fine, usually circular, die capillaries as molten fibers into converging high velocity gas (e.g., air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al., which is incorporated herein in its entirety by reference thereto for all purposes. Generally speaking, meltblown fibers may be microfibers that are substantially continuous or discontinuous, generally smaller than 10 microns in diameter, and generally tacky when deposited onto a collecting surface.

As used herein, the term “spunbond web” generally refers to a web containing small diameter substantially continuous fibers. The fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat No. 3,338,992 to Kinney, U.S. Pat. No. 3,341,394 to Kinney, U.S. Pat No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. Spunbond fibers are generally not tacky when they are deposited onto a collecting surface. Spunbond fibers may sometimes have diameters less than about 40 microns, and are often between about 5 to about 20 microns.

As used herein, the term “coform” generally refers to composite materials comprising a mixture or stabilized matrix of thermoplastic fibers and a second non-thermoplastic material. As an example, coform materials may be made by a process in which at least one meltblown die head is arranged near a chute through which other materials are added to the web while it is forming. Such other materials may include, but are not limited to, fibrous organic materials such as woody or non-woody pulp such as cotton, rayon, recycled paper, pulp fluff and also superabsorbent particles, inorganic and/or organic absorbent materials, treated polymeric staple fibers and so forth. Some examples of such coform materials are disclosed in U.S. Pat. No. 4,100,324 to Anderson, et al., U.S. Pat. No. 5,284,703 to Everhart, et al., and U.S. Pat. No. 5,350,624 to Georger, et al., each of which are incorporated herein in their entirety by reference thereto for all purposes.

As used herein, the term “thermal point bonding” generally refers to a process performed, for example, by passing a material between a patterned roll (e.g., calender roll) and another roll (e.g., anvil roll), which may or may not be patterned. One or both of the rolls are typically heated.

As used herein, the term “ultrasonic bonding” generally refers to a process performed, for example, by passing a material between a sonic horn and a patterned roll (e.g., anvil roll). For instance, ultrasonic bonding through the use of a stationary horn and a rotating patterned anvil roll is described in U.S. Pat. No. 3,939,033 to Grgach, et al., U.S. Pat. No. 3,844,869 to Rust Jr., and U.S. Pat. No. 4,259,399 to Hill, which are incorporated herein in their entirety by reference thereto for all purposes. Moreover, ultrasonic bonding through the use of a rotary horn with a rotating patterned anvil roll is described in U.S. Pat. No. 5,096,532 to Neuwirth, et al., U.S. Pat. No. 5,110,403 to Ehlert, and U.S. Pat. No. 5,817,199 to Brennecke, et al., which are incorporated herein in their entirety by reference thereto for all purposes. Of course, any other ultrasonic bonding technique may also be used in the present invention.

### DETAILED DESCRIPTION

Reference now will be made in detail to various embodiments of the invention, one or more examples of which are set forth below. Each example is provided by way of explanation, not limitation, of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

Generally speaking, the present disclosure is directed to a multilayered elastomeric composition, such as a film or a fiber, that contains a core layer, and one or more outer skin layers. Particularly the present disclosure has found that a skin layer that includes an elastomeric resin and at least one non-elastic polyolefin may be used in conjunction with a polyolefin elastomer core layer to provide an elastomeric composition with excellent elastic efficiency that also exhibits improved non-blocking properties. Thus, in one example, the elastomeric composition according to the present disclosure may display excellent elastic efficiency before and after being wound into a roll or spool without the addition of a further non-elastic non-blocking layer or layers. Furthermore, it has been found that the excellent non-blocking properties are exhibited even when the one or more skin layers form about 40% by weight or less of the total weight of the elastomeric composition, such as about 35% or less, such as about 30% or less, such as about 25% or less, such as about 20% or less, such as about 15% or less, such as about 10% or less of the total weight of the elastomeric composition.

For instance, in one aspect, an elastomeric composition according to the present disclosure may be formed into a film or a fiber, and may exhibit a hysteresis loss of about 60% or less, such as about 57.5% or less, such as about 55% or less, such as about 52.5% or less, such as about 50% or less, such as about 47.5% or less, at 120% elongation, for which testing methods are defined in greater detail in the examples below, or any ranges or values therebetween. In a further aspect, the elastomeric composition that includes a film or fiber according to the present disclosure may exhibit a hysteresis loss of about 45% or less, such as about 42.5% or less, such as about 40% or less, such as about 37.5% or less, such as about 35% or less, such as about 32.5% or less, after two cycles of stretching at 120% elongation, or any ranges or values therebetween.

Furthermore, the elastomeric composition according to the present disclosure may be formed into a film or a fiber and may exhibit a percent set of about 32.5% or less, such as about 30% or less, such as about 27.5% or less, such as about 25% or less, such as about 22.5% or less, at 120% elongation as discussed in greater detail in the examples below, or any ranges or values therebetween. Furthermore, the elastomeric composition that includes a film or fiber according to the present disclosure may exhibit a percent set of about of about 35% or less, such as about 32.5% or less, such as about 30% or less, such as about 27.5% or less, after two cycles of stretching at 120% elongation, or any ranges or values therebetween.

Moreover, the elastomeric composition according to the present disclosure may be formed into a film or a fiber and may exhibit a load at 120% elongation of about 375 gram-force (gF) or greater, such as about 400 gF or greater, such as about 425 gF or greater, or any ranges or values therebetween. Additionally or alternatively, the elastomeric composition that includes a film or fiber according to the present disclosure may exhibit a load at 120% elongation after a second stretching cycle of about 275 gF or greater, such as about 300 gF or greater, such as about 325 gF or greater, or any ranges or values therebetween.

In one aspect, the elastomeric composition may have more than one skin layer, such as an aspect wherein the elastomeric composition is a film. In such an aspect, the elastomeric film may contain a core layer that is “sandwiched” between two skin layers. Each of the skin layers may be the same or different, of which the components will be discussed in greater detail below. Thus, in one aspect, each of the skin layers may form a portion of the total elastomeric composition by weight as discussed above. Alternatively, in one aspect, the total weight of skin layers, whether one, two, or more, are according to the weight percentages discussed above.

Regardless of the number of the number of skin layers, in one aspect, an elastomer that may be used in the core layer, the skin layer, or both the skin layer and core layer may be formed from one or more of a variety of thermoplastic elastomeric and plastomeric polymers, such as elastomeric polyesters, elastomeric polyurethanes, elastomeric polyamides, elastomeric copolymers, elastomeric polyolefins, and so forth. In one particular embodiment, elastomeric semi-crystalline polyolefins are employed due to their unique combination of mechanical and elastomeric properties. Semi-crystalline polyolefins have or are capable of exhibiting a substantially regular structure. For example, semi-crystalline polyolefins may be substantially amorphous in their undeformed state, but form crystalline domains upon stretching. The degree of crystallinity of the olefin polymer may be from about 3% to about 60%, in some embodiments from about 5% to about 45%, in some embodiments from about 5% to about 30%, and in some embodiments, from about 5% and about 15%. Likewise, the semi-crystalline polyolefin may have a latent heat of fusion (ΔH_{f}), which is another indicator of the degree of crystallinity, of from about 15 to about 210 Joules per gram (“J/g”), in some embodiments from about 20 to about 100 J/g, in some embodiments from about 20 to about 65 J/g, and in some embodiments, from 25 to about 50 J/g. The semi-crystalline polyolefin may also have a Vicat softening temperature of from about 10° C. to about 100° C., in some embodiments from about 20° C. to about 80° C., and in some embodiments, from about 30° C. to about 60° C. The semi-crystalline polyolefin may have a melting temperature of from about 20° C. to about 120° C., in some embodiments from about 35° C. to about 90° C., and in some embodiments, from about 40° C. to about 80° C. The latent heat of fusion (ΔH_{f}) and melting temperature may be determined using differential scanning calorimetry (“DSC”) in accordance with ASTM D-3417 as is well known to those skilled in the art. The Vicat softening temperature may be determined in accordance with ASTM D-1525.

Exemplary semi-crystalline polyolefins include polyethylene, polypropylene, as well as their blends and copolymers thereof. In one particular embodiment, a polyethylene is employed that is a copolymer of ethylene and an α-olefin, such as a C₃-C₂₀ α-olefin or C₃-C₁₂ α-olefin. Suitable α-olefins may be linear or branched (e.g., one or more C₁-C₃ alkyl branches, or an aryl group). Specific examples include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene, and 1-octene. The ethylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %.

The density of the polyethylene may vary depending on the type of polymer employed, but generally ranges from about 0.85 g/cm³ to about 0.96 g/cm³. Polyethylene “plastomers”, for instance, may have a density in the range of from 0.85 g/cm³ to 0.91 g/cm³. Likewise, “linear low density polyethylene” (“LLDPE”) may have a density in the range of from about 0.91 g/cm³ to about 0.94 g/cm³; “low density polyethylene” (“LDPE”) may have a density in the range of from about 0.91 g/cm³ to about 0.94 g/cm³; and “high density polyethylene” (“HDPE”) may have density in the range of from 0.94 g/cm³ to 0.96 g/cm³. Densities may be measured in accordance with ASTM 1505.

Particularly suitable polyethylene copolymers are those that are “linear” or “substantially linear.” The term “substantially linear” means that, in addition to the short chain branches attributable to comonomer incorporation, the ethylene polymer also contains long chain branches in the polymer backbone. “Long chain branching” refers to a chain length of at least 6 carbons. Each long chain branch may have the same comonomer distribution as the polymer backbone and be as long as the polymer backbone to which it is attached. Preferred substantially linear polymers are substituted with from 0.01 long chain branch per 1000 carbons to 1 long chain branch per 1000 carbons, and in some embodiments, from 0.05 long chain branch per 1000 carbons to 1 long chain branch per 1000 carbons. In contrast to the term “substantially linear”, the term “linear” means that the polymer lacks measurable or demonstrable long chain branches. That is, the polymer is substituted with an average of less than 0.01 long chain branch per 1000 carbons.

The density of a linear ethylene/α-olefin copolymer is a function of both the length and amount of the α-olefin. That is, the greater the length of the α-olefin and the greater the amount of α-olefin present, the lower the density of the copolymer. Although not necessarily required, linear polyethylene “plastomers” are particularly desirable in that the content of α-olefin short chain branching content is such that the ethylene copolymer exhibits both plastic and elastomeric characteristics—i.e., a “plastomer.” Because polymerization with α-olefin comonomers decreases crystallinity and density, the resulting plastomer normally has a density lower than that of polyethylene thermoplastic polymers (e.g., LLDPE), but approaching and/or overlapping that of an elastomer. For example, the density of the polyethylene plastomer may be 0.91 g/cm³ or less, in some embodiments, from about 0.85 g/cm³ to about 0.88 g/cm³, and in some embodiments, from about 0.85 g/cm³ to about 0.87 g/cm³. Despite having a density similar to elastomers, plastomers generally exhibit a higher degree of crystallinity and may be formed into pellets that are non-adhesive and relatively free flowing.

The distribution of the α-olefin comonomer within a polyethylene plastomer is typically random and uniform among the differing molecular weight fractions forming the ethylene copolymer. This uniformity of comonomer distribution within the plastomer may be expressed as a comonomer distribution breadth index value (“CDBI”) of 60 or more, in some embodiments 80 or more, and in some embodiments, 90 or more. Further, the polyethylene plastomer may be characterized by a DSC melting point curve that exhibits the occurrence of a single melting point peak occurring in the region of 50 to 110° C. (second melt rundown).

Suitable plastomers for use in the present disclosure are ethylene-based copolymer plastomers available under the designation EXACT™ from ExxonMobil Chemical Company of Houston, Tex., ENGAGE™ and AFFINITY™ from Dow Chemical Company of Midland, Mich., and olefin block copolymers available from Dow Chemical Company of Midland, Mich. under the trade designation INFUSE™, such as INFUSE™ 9807. A polyethylene that can be used in a fiber of the present disclosure is DOW™ 61800.41. Still other suitable ethylene polymers are available from The Dow Chemical Company under the designations DOWLEX™ (LLDPE), ASPUN™ (LLDPE), and ATTANE™ (ULDPE). Other suitable ethylene polymers are described in U.S. Pat. No. 4,937,299 to Ewen et al.; U.S. Pat. No. 5,218,071 to Tsutsui et al.; U.S. Pat. No. 5,272,236 to Lai, et al.; and U.S. Pat. No. 5,278,272 to Lai, et al., which are incorporated herein in their entirety by reference thereto for all purposes.

Of course, the present disclosure is by no means limited to the use of ethylene polymers. For instance, propylene polymers may also be suitable for use as a semi-crystalline polyolefin. Suitable plastomeric propylene polymers may include, for instance, copolymers or terpolymers of propylene include copolymers of propylene with an α-olefin (e.g., C₃-C₂₀), such as ethylene, 1-butene, 2-butene, the various pentene isomers, 1-hexene, 1-octene, 1-nonene, 1-decene, 1-unidecene, 1-dodecene, 4-methyl-1-pentene, 4-methyl-1-hexene, 5-methyl-1-hexene, vinylcyclohexene, styrene, etc. The comonomer content of the propylene polymer may be about 35 wt. % or less, in some embodiments from about 1 wt. % to about 20 wt. %, and in some embodiments, from about 2 wt. % to about 10 wt. %. Preferably, the density of the polypropylene (e.g., propylene/α-olefin copolymer) may be 0.91 grams per cubic centimeter (g/cm³) or less, in some embodiments, from 0.85 to 0.88 g/cm³, and in some embodiments, from 0.85 g/cm³ to 0.87 g/cm³. Suitable propylene-based copolymer plastomers are commercially available under the designations VISTAMAXX™ (e.g., 2330, 6202, and 6102), a propylene-ethylene copolymer-based plastomer from ExxonMobil Chemical Co. of Houston, Tex.; FINA™ (e.g., 8573) from Atofina Chemicals of Feluy, Belgium; TAFMER™ available from Mitsui Petrochemical Industries; and VERSIFY™ available from Dow Chemical Co. of Midland, Mich. Other examples of suitable propylene polymers are described in U.S. Pat. No. 6,500,563 to Datta, et al.; U.S. Pat. No. 5,539,056 to Yang, et al.; and U.S. Pat. No. 5,596,052 to Resconi, et al., which are incorporated herein in their entirety by reference thereto for all purposes.

Any of a variety of known techniques may generally be employed to form the semi-crystalline polyolefins. For instance, olefin polymers may be formed using a free radical or a coordination catalyst (e.g., Ziegler-Natta). Preferably, the olefin polymer is formed from a single-site coordination catalyst, such as a metallocene catalyst. Such a catalyst system produces ethylene copolymers in which the comonomer is randomly distributed within a molecular chain and uniformly distributed across the different molecular weight fractions. Metallocene-catalyzed polyolefins are described, for instance, in U.S. Pat. No. 5,571,619 to McAlpin et al; U.S. Pat. No. 5,322,728 to Davis et al.; U.S. Pat. No. 5,472,775 to Obijeski et al.; U.S. Pat. No. 5,272,236 to Lai et al.; and U.S. Pat. No. 6,090,325 to Wheat, et al., which are incorporated herein in their entirety by reference thereto for all purposes. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, and so forth. Polymers made using metallocene catalysts typically have a narrow molecular weight range. For instance, metallocene-catalyzed polymers may have polydispersity numbers (M_{w}/Mₙ) of below 4, controlled short chain branching distribution, and controlled isotacticity.

The melt flow index (MI) of the semi-crystalline polyolefins may generally vary, but is typically in the range of about 0.1 grams per 10 minutes to about 100 grams per 10 minutes, in some embodiments from about 0.5 grams per 10 minutes to about 30 grams per 10 minutes, and in some embodiments, about 1 to about 10 grams per 10 minutes, determined at 190° C. The melt flow index is the weight of the polymer (in grams) that may be forced through an extrusion rheometer orifice (0.0825-inch diameter) when subjected to a force of 5000 grams in 10 minutes at 190° C., and may be determined in accordance with ASTM Test Method D1238-E.

While the elastomer has been thus far discussed for both the core layer and the skin layer together, it should be understood that the core layer and the skin layer may contain the same elastomer(s) or a different elastomer or elastomer(s). For instance, in one aspect, the core layer may contain a polyethylene based copolymer elastomer as discussed above (e.g., INFUSE™), whereas the skin layer may contain a polypropylene based copolymer elastomer (e.g., VERSIFY™).

Additionally or Alternatively, the core layer and skin layer may each be formed from either a propylene based copolymer or an ethylene based copolymer (or any other elastomer discussed above), however, the core layer is formed from an elastomer having a “medium” to “high” molecular weight, whereas the skin layer is formed from an elastomer having a “low” molecular weight. For instance, in one aspect, the “medium” to “high” molecular weight elastomer can have a number average molecular weight of about 10,000 g/mol to about 70,000 g/mol, such as about 12,500 g/mol to about 67,500 g/mol, such as about 15,000 g/mol to about 65,000, such as about 17,500 g/mol to about 62,500 g/mol, such as about 20,000 g/mol to about 60,000 g/mol, or any ranges or values therebetween. Furthermore, a “low” molecular weight elastomer according to the present disclosure may have a number average molecular weight of about 1,000 g/mol to about 10,000 g/mol, such as about 2,000 g/mol to about 9,000 g/mol, such as about 3,000 g/mol to about 8,000 g/mol, such as about 4,000 g/mol to about 7,000 g/mol, such as about 4,500 g/mol to about 6,500 g/mol or any ranges or values therebetween.

For instance, in one aspect, a ratio of the average molecular weight of the total elastomer or elastomers in the core layer to a ratio of the average molecular weight of the total elastomer or elastomers in the skin layer may be from about 10:1 to about 1.1:1, such as about 7.5:1 to about 1.5:1, such as about 5:1 to about 2:1, or any ranges or valued therebetween. Without wishing to be bound by theory, the present disclosure has found that by using a lower molecular weight elastomer in the skin layer as compared to the core layer, an increase in tension forces upon stretching which are normally exhibited when using a non-blocking skin layer may be avoided. Thus, in one aspect, a lower molecular weight elastomer is used in the skin layer, which can further improve the elastic efficiency of the composition according to the present disclosure.

Nonetheless, as discussed above, the present disclosure has found that by including a non-elastomeric polyolefin material in combination with the elastomer in the skin layer, a non-blocking skin layer can be formed that does not inhibit the elastic efficiency of the composition. Thus, in one aspect, the non-elastomeric polyolefin may include generally inelastic polymers, such as conventional polyolefins, (e.g., polyethylene), low density polyethylene (LDPE), Ziegler-Natta catalyzed linear low density polyethylene (LLDPE), etc.), ultra low density polyethylene (ULDPE), polypropylene, polybutylene, etc.; polytetrafluoroethylene; polyesters, e.g., polyethylene terephthalate (PET), etc.; polyvinyl acetate; polyvinyl chloride acetate; polyvinyl butyral; acrylic resins, e.g., polyacrylate, polymethylacrylate, polymethylmethacrylate, etc.; polyamides, e.g., nylon; polyvinyl chloride; polyvinylidene chloride; polystyrene; polyvinyl alcohol; polyurethanes; polylactic acid; copolymers and mixtures thereof; and so forth. For instance, the skin layer(s) can include an LLDPE available from Dow Chemical Co. of Midland, Mich., such as DOWLEX™ 2517 or DOWLEX™ 2047, or a combination thereof, or Westlake Chemical Corp. of Houston, Tex. Furthermore, in one aspect, the non-blocking polyolefin material may be other suitable ethylene polymers, such as those available from The Dow Chemical Company under the designations ASPUN™ (LLDPE) and ATTANE™ (ULDPE).

Furthermore, the present disclosure has found that the non-elastomeric polyolefin(s) can be employed in the skin layer in a relatively small amount, and still provide a skin layer with improved non-blocking properties. Thus, in one aspect, the non-elastomeric polyolefin(s) constitute about 5 wt. % to about 70 wt. % of the skin layer, such as about 10 wt. % to about 65 wt. %, such as about 15 wt. % to about 60 wt. %, such as about 20 wt. % to about 55 wt. %, such as about 25 wt. % to about 50 wt. % of the total weigh of the skin layer(s), or any ranges or values therebetween.

Notwithstanding the elastomer(s) selected for the skin and core layers, and the non-elastomeric polyolefin selected for the skin layer, a single polymer as discussed above can be used to form the elastomer and/or the non-elastomeric polyolefin of the core, the skin, or both the core and the skin in amount up to 100 wt. % based on the total weight of the nonwoven web material, such as from about 75 wt. % to about 99 wt. %, such as from about 80 wt. % to about 98 wt. %, such as from about 85 wt. % to about 95 wt. %. However, in other embodiments, the elastomer and/or the non-elastomeric polyolefin can include two or more polymers from the polymers discussed above.

Furthermore, regardless of the elastomer(s) and non-elastomeric polyolefin selected, in one aspect the core layer is present in an amount of about 50% to about 97.5% by weight of the total weight of the elastomeric composition, such as about 60% to about 95%, such as about 70% to about 92.5%, such as about 80% to about 90% by weight of the total weight of the elastomeric composition, or any ranges or values therebetween.

Notwithstanding the above discussed aspects, in one aspect, either in addition to or instead of the non-elastic polyolefin material, the skin layer may include a non-blocking elastomer with some degree of elasticity and may, in some aspects, be formed from any of the materials discussed above. In some aspects, such layers may be formed from a thermoplastic composition that is less elastic than the elastomeric composition discussed above. For example, one or more elastic layers may be formed primarily from substantially amorphous elastomers (e.g., styrene-olefin copolymers) and one or more thermoplastic layers may be formed from polyolefin plastomers (e.g., single-site catalyzed ethylene or propylene copolymers), which are described in more detail above. Although possessing some elasticity, such polyolefins are generally less elastic than substantially amorphous elastomers.

Furthermore, in one aspect, the skin layer may include one or more inorganic fillers, either in addition to, or instead of, the non-elastic polyolefin. Thus, in one aspect, the skin layer includes one or more of calcium carbonate (CaCO₃), various kinds of clay, silica (SO₂), alumina, barium sulfate, sodium carbonate, talc, magnesium sulfate, titanium dioxide, zeolites, aluminum sulfate, cellulose-type powders, diatomaceous earth, magnesium sulfate, magnesium carbonate, barium carbonate, kaolin, mica, carbon, calcium oxide, magnesium oxide, aluminum hydroxide, pulp powder, wood powder, cellulose derivative, polymer particles, chitin and chitin derivatives. In one aspect, the inorganic particles may include calcium carbonate, diatomaceous earth, or combinations thereof.

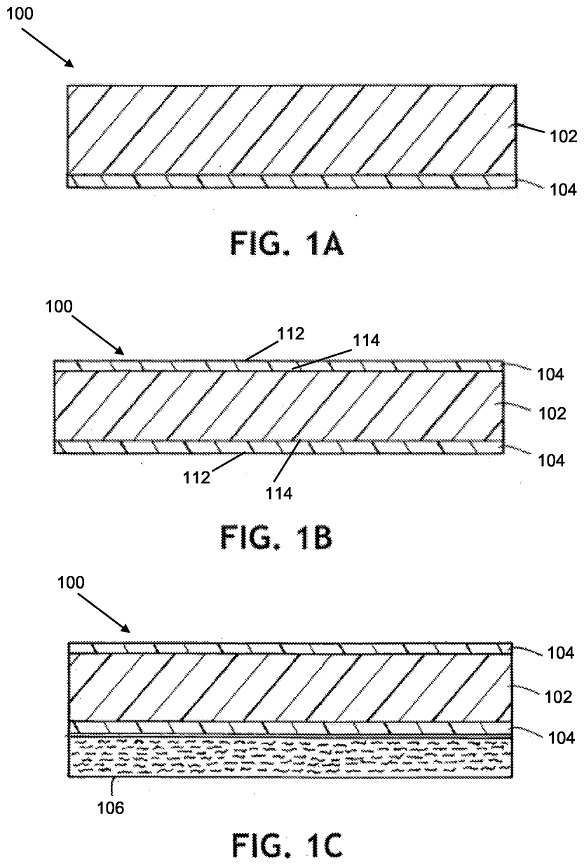

Nonetheless, referring to FIGS. 1A-1C, In one aspect according to the present disclosure, the elastomeric composition is a multilayer film 100. As shown in FIG. 1A, in one aspect, the film 100 includes a skin layer 104 and a core layer 102. Regardless of the orientation of the skin layer 104 above or below the core layer 102, the skin layer and core layer are formed as discussed above.

Furthermore, as shown in FIG. 1B, an elastomeric composition according to the present disclosure may again be a multilayer film 100, but may include two outer skin layers 104 “sandwiching” a core layer 102. As discussed above, each skin layer 104 may be the same or different, and the skin layers 104 and core layer 102 are formed as discussed above.

Additionally, in one aspect, the present disclosure may also generally include an elastomeric film 100 laminated to a backing and/or facing 106. In one aspect, the backing and/or facing 106 may be a nonwoven article. Nonetheless, lamination according to the present disclosure may be further discussed below.

As will be discussed in greater detail below, in one aspect, a film formed as an elastomeric composition according to the present disclosure may be embossed or patterned by using an embossed or patterned chill roll. Thus, referring to FIG. 1B for example, in one aspect, each skin layer 104 may have an inner side 110 adjacent to the core 102, and an outer side 112 opposite the inner edge. Thus, in one aspect, the portion of the film referred to below for embossing or patterning may refer to the outer side 112 of the skin layer 104.

In yet a further aspect, the elastomeric composition according to the present disclosure may also include fibers, such as fibers that may be used to form a nonwoven material. The fibers can be multicomponent fibers having and a skin-core arrangement or side-by-side arrangement. For instance, in a skin-core multicomponent fiber arrangement, the skin can include any of the elastomers discussed above in regards to the skin layer, while the core can include elastomers discussed above in regards to the core layer.

For instance, in some aspect, the fibers can have a skin-core arrangement where the skin can form about 40% by weight or less of the total weight of the fiber, such as about 35% or less, such as about 30% or less, such as about 25% or less, such as about 20% or less, such as about 15% or less, such as about 10% or less of the total weight of the fiber. Furthermore, in one aspect, the core may form from about 50% to about 97.5% by weight of the total weight of the fiber, such as about 60% to about 95%, such as about 70% to about 92.5%, such as about 80% to about 90% by weight of the total weight of the fiber, or any ranges or values therebetween.

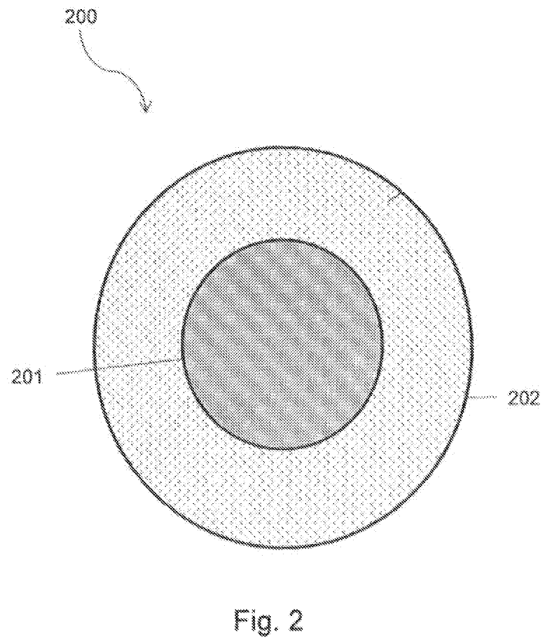

Nonetheless, turning to FIG. 2, a bicomponent fiber 200 utilizing a skin/core arrangement is shown. The core 201 can be formed from an elastomer as discussed above, while the sheath 202 can be formed from an elastomer and a non-elastomeric polyolefin as discussed above. In such an aspect, a fiber 200 may be wound after formation, and exhibit improved non-blocking properties as discussed above in regards to wound films while exhibiting excellent elastic efficiency. Furthermore, the fibers may also exhibit improved laydown and other processing improvements due to the improvements in non-blocking, while maintaining the elastic efficiency.

Regardless of the form of the elastomeric composition, additives may also be incorporated into the elastomeric composition, such as melt stabilizers, processing stabilizers, heat stabilizers, light stabilizers, antioxidants, heat aging stabilizers, whitening agents, antiblocking agents, viscosity modifiers, etc. Viscosity modifiers may also be employed, such as polyethylene wax (e.g., EPOLENE™ C-10 from Eastman Chemical). Phosphite stabilizers (e.g., IRGAFOS available from Ciba Specialty Chemicals of Tarrytown, N.Y. and DOVERPHOS available from Dover Chemical Corp. of Dover, Ohio) are exemplary melt stabilizers. In addition, hindered amine stabilizers (e.g., CHIMASSORB available from Ciba Specialty Chemicals) are exemplary heat and light stabilizers. Further, hindered phenols are commonly used as an antioxidant in the production of films. Some suitable hindered phenols include those available from Ciba Specialty Chemicals of under the trade name IRAGANOX™, such as IRGANOX™ 1076, 1010, or E 201. When employed, such additives (e.g., antioxidant, stabilizer, etc.) may each be present in an amount from about 0.001 wt. % to about 25 wt. %, in some embodiments, from about 0.005 wt. % to about 20 wt. %, and in some embodiments, from 0.01 wt. % to about 15 wt. % of the nonwoven web material.

Nonetheless, in one aspect, the present disclosure may also generally include forming an elastomeric composition according to the present disclosure.

Multilayer films may be prepared by co-extrusion of the layers, extrusion coating, or by any conventional layering process. Such multilayer films normally contain at least one core layer and at least one skin layer, but may contain any number of layers desired. For example, the multilayer film may be formed from a core layer and one or more skin layers, where the skin and core layers are formed using polymers as discussed above. Regardless of the method used, the multilayer film may be cast onto a chill roller and cooled. The multilayer film may be optionally stretched, but preferable, in one aspect, may be wound into a roll prior to stretching or lamination for storage until it is desired to form a laminated article.

In one aspect, the chill roller may be embossed or patterned. In such an aspect, the film may therefore become embossed or patterned during the chill roll process. Particularly, the present disclosure has found that such patterning may further improve the non-blocking properties of the film. Thus, in one aspect, the portion of the film that is subjected to embossing or patterning may be one or more of the skin layers.

Nonetheless, after chilling, the film may be wound and stored for further processing as discussed above, or may be stretched and laminated to a facing and/or backing utilizing one of the above defined lamination methods, as is known in the art.

Furthermore, in one aspect, the elastomeric composition may be formed into a bicomponent fiber. Particularly, multicomponent fibers can be formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art, and so forth. Various methods for forming multicomponent fibers are described in U.S. Pat. No. 4,789,592 to Taniguchi et al. U.S. Pat. No. 5,336,552 to Strack et al., U.S. Pat. No. 5,108,820 to Kaneko, et al., U.S. Pat. No. 4,795,668 to Kruege, et al., U.S. Pat. No. 5,382,400 to Pike, et al., U.S. Pat. No. 5,336,552 to Strack, et al., and U.S. Pat. No. 6,200,669 to Marmon, et al., which are incorporated herein in their entirety by reference thereto for all purposes. Multicomponent fibers having various irregular shapes may also be formed, such as described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

In any event, whether the fiber is used to form a nonwoven material formed by meltblowing, spunbonding, or any other nonwoven web material technique, the resulting extruded fiber can be arranged such that the skin layer is present on an exposed surface of the fiber.

Regardless of whether a film or fiber is formed, in one aspect, the elastomeric composition according to the present disclosure may be able to easily undergo post-formation processing, such as aperturing, winding, and unwinding, due to the unique blend of the core and skin layers, either before or after lamination to a facing and/or backing.

The elastomeric composition of the present disclosure, having the characteristics discussed above, may be used in a wide variety of applications. For instance, in one aspect, the elastomeric composition of the present disclosure may be used in an absorbent article. An “absorbent article” generally refers to any article capable of absorbing water or other fluids. Examples of some absorbent articles include, but are not limited to, personal care absorbent articles, such as diapers, training pants, absorbent underpants, incontinence articles, feminine hygiene products (e.g., sanitary napkins, pantiliners, etc.), swim wear, baby wipes, and so forth; medical absorbent articles, such as garments, fenestration materials, underpads, bedpads, bandages, absorbent drapes, and medical wipes; food service wipers; clothing articles; and so forth. Several examples of such absorbent articles are described in U.S. Pat. No. 5,649,916 to DiPalma, et al.; U.S. Pat. No. 6,110,158 to Kielpikowski; U.S. Pat. No. 6,663,611 to Blaney, et al. Still other suitable articles are described in U.S. Patent Application Publication No. 2004/0060112 A1 to Fell et al., as well as U.S. Pat. No. 4,886,512 to Damico et al.; U.S. Pat. No. 5,558,659 to Sherrod et al.; U.S. Pat. No. 6,888,044 to Fell et al.; and U.S. Pat. No. 6,511,465 to Freiburger et al. Materials and processes suitable for forming such absorbent articles are well known to those skilled in the art. Typically, absorbent articles include a substantially liquid-impermeable layer (e.g., outer cover), a liquid-permeable layer (e.g., bodyside liner, surge layer, etc.), and an absorbent core. In one particular embodiment, the composite of the present invention may be used in providing a waist section, leg cuff/gasketing, ears, side panels, or an outer cover.

The present disclosure may be better understood with reference to the following example.

Test Methods

Multi-Cycle Stress/Strain Test for Raw Materials

The Multi-cycle Stress/Strain Test is a two-cycle elongation and recovery test used to measure the elongation and recovery characteristics of elastic raw materials and elastic material composites. In particular, the test may be used to determine what effects, if any, the application of the described formulations to the substrates have on the elongation and recovery characteristics thereof. Deterioration of substrate properties measured by this test are those that manifest as a loss of tension, or resistance to elongation, which may result in extreme elongation on application of a force, as with sagging.

The test measures load values of a test sample placed under a particular amount of strain (e.g., elongated to a particular elongation). Such load values are determined during both the elongation and recovery phases of the test, and during each of the two cycles. For this example, the load values was set at 120% elongation. In general, a decrease in the amount of the load retained after treatment indicates a negative impact on the elastic characteristics of the substrate, even in the absence of visible deterioration or delamination of the substrate.

“Percent set” is the measure of the amount of the material stretched from its original length after being cycled (the immediate deformation following the cycle test). The percent set is where the retraction curve of a cycle crosses the elongation axis. The remaining strain after removal of the applied stress is measured as the percent set.

A multilayered film labeled Sample 1 was formed from a three extruder systems with separate flows that go through a feedblock system the maintains the separate flows up until the slotted die. The core layer contains an ethylene based copolymer sold by Dow Chemical Company of Midland, Mich. under the trade designation INFUSE™, and two skin layers were formed on either side of the core layer from a blend of 50 wt. % of a propylene based copolymer sold available from Dow Chemical Co. of Midland, Mich. under the tradename VERSIFY™ and 50 wt. % of a blend of linear low density polyethylenes sold under the tradenames Dowlex™ 2517 and Dowlex™ 2035. The extruded layers exit the die to a chill roll having a temperature of 60° F. to 100° F., in which the extrudate is quenched into a film. The film was then wound into a roll and tested for various properties, as shown in Tables 1 and 2.

A non-hydrogenated styrenic block copolymer sold by Tredegar was formed into a film in the same manner as example 1. Both films were tested for various properties, as shown in Tables 1 and 2.

TABLE 1

| | Hysteresis | Percent Set | Load @120% | Load @120% |
|---|---|---|---|---|
| | Loss-Cycle | (10 g)-Cycle | Elong.-Cycle | Return-Cycle |
| Code | 1 (%) | 1 (%) | 1 (gF) | 1 (gF) |
| Sample 1 | 47.5 | 22.6 | 429 | 228.5 |
| Control | 62.4 | 32.6 | 353.9 | 155.6 |

TABLE 2

| | | Percent | Load @ | | Load |
|---|---|---|---|---|---|
| | Hysteresis | Set | 120% | Load @ | @120% |
| | Loss- | (10 g)- | Elong.- | Extension | Return- |
| | Cycle 2 | Cycle 2 | Cycle | End-Cycle 2 | Cycle 2 |
| Code | (%) | (%) | 2(F) | (gF) | (gF) |
| Sample 1 | 32.7 | 26 | 329 | 643.4 | 222.6 |
| Control | 43.9 | 35.3 | 249.8 | 764 | 153.6 |

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. An elastomeric composition comprising:
a core layer; and
at least one skin layer;
wherein the at least one skin layer comprises 30 wt. % or less of the total weight of the elastomeric composition;
the skin layer comprises an olefin based elastomer and at least one non-elastomeric polyolefin; and
wherein the elastomeric composition exhibits a hysteresis loss of about 60% or less after stretching at 120% elongation.

2. The elastomeric composition according to claim 1, wherein the elastomeric composition is a film.

3. The elastomeric composition according to claim 1, wherein the elastomeric composition is a fiber.

4. The elastomeric composition of claim 1, wherein the olefin-based elastomer comprises an ethylene/α-olefin copolymer, a propylene/α-olefin copolymer, or a combination thereof.

5. The elastomeric composition of claim 1, wherein the core layer comprises a core olefin based elastomer, wherein the core olefin-based elastomer comprises an ethylene/α-olefin copolymer, a propylene/α-olefin copolymer, or a combination thereof.

6. The elastomeric composition of claim 1, wherein the core layer comprises a core olefin based elastomer and a second olefin based elastomer.

7. The elastomeric composition of claim 1, wherein the core olefin based elastomer and the second olefin based elastomer comprise an ethylene/α-olefin copolymer.

8. The elastomeric composition of claim 1, wherein the olefin based elastomer and the core olefin based elastomer and/or the olefin based elastomer and the second olefin based elastomer are formed from different elastomers.

9. The elastomeric composition of claim 1, wherein the olefin-based elastomer comprises a propylene/α-olefin copolymer.

10. The elastomeric composition of claim 1, wherein the core olefin based elastomer and/or the second olefin based elastomer comprises an ethylene/α-olefin copolymer.

11. The elastomeric composition of claim 1, wherein the olefin-based elastomer comprises an ethylene/α-olefin copolymer.

12. The elastomeric composition of claim 1, wherein the core olefin based elastomer and/or the second olefin based elastomer comprises a propylene/α-olefin copolymer.

13. The elastomeric composition of claim 1, wherein the olefin based elastomer has a lower number average molecular weight than the core olefin based elastomer, second olefin based elastomer, or an average molecular weight of the core olefin based elastomer and the second olefin based elastomer.

14. The elastomeric composition of claim 1, wherein a ratio of an average molecular weight of the core olefin based elastomer, the second olefin based elastomer, or an average molecular weight of the core olefin based elastomer and the second olefin based elastomer, to an average molecular weight of the olefin based elastomer is from about 10:1 to 1.1:1.

15. The elastomeric composition of claim 1, wherein the non-elastomeric olefin is a linear low density polyethylene.

16. The elastomeric composition of claim 1, wherein the non-elastomeric olefin comprises about 20 wt. % or less of the total weight of the elastomeric composition.

17. The elastomeric composition of claim 1, wherein the non-elastomeric olefin comprises about 15% or less of the total weight of the elastomeric composition.

18. The elastomeric composition of claim 1, wherein the film comprises a core layer and one skin layer.

19. The elastomeric composition of claim 1, wherein the film comprises a core layer, a first skin layer, and a second skin layer.

20. The elastomeric composition of claim 1, wherein the fiber comprises a core surrounded by a single skin layer.

21. The elastomeric composition of claim 1, wherein the at least one skin layer further comprises inorganic particles.

22. The elastomeric composition of claim 1, wherein the at least one skin layer has an inner side adjacent to the core and an outer side opposite the inner side, wherein the outer side is embossed or patterned.

23. The elastomeric composition of claim 1, wherein the elastomeric composition is wound after formation.

24. The elastomeric composition of claim 23, wherein the elastomeric composition is wound prior to stretching or lamination.
